(19) United States
(12) Patent Application Publication
(10) Pub. No.: US 2009/0030721 A1
(43) Pub. Date: Jan. 29, 2009

(54) APPARATUS AND METHOD FOR MONITORING USE OF RESOURCES BY HEALTHCARE EMPLOYEES

(76) Inventors: Luis Garcia, Slinger, WI (US); Bryan Dickerson, Neosho, WI (US); Jeffrey Herbert Peterson, Jackson, WI (US); Michael D. Cook, Watertown, WI (US); Nathan August Schleifer, Grafton, WI (US)

Correspondence Address: QUARLES & BRADY LLP, 411 E. WISCONSIN AVENUE, SUITE 2040, MILWAUKEE, WI, 53202-4497, US

(21) Appl. No.: 11/876,451

(22) Filed: Oct. 22, 2007

Related U.S. Application Data
(63) Continuation of application No. 11/829,666, filed on Jul. 27, 2007.

(51) Int. Cl. G06Q 10/00; G06Q 50/00

(52) U.S. Cl. 705/2

(57) ABSTRACT

A system that monitors use of resources by healthcare employees includes a plurality of resource identification devices located adjacent different resources, such as pieces of plumbing fixture, medical equipment, documents and hospital rooms. Each resource identification device emits a wireless signal containing a resource identifier. A plurality of healthcare employees carry separate data acquisition devices which receive the wireless signal when nearby a resource identification device. Upon receiving a wireless signal, the data acquisition device records the date and time of day and the resource identifier carried by the wireless signal. The information stored in each data acquisition device along with an employee identifier are employed to monitor the activity and use of resources by employees, and create reports about activity and use of the resources by the healthcare employees.

### CROSS-REFERENCE TO RELATED APPLICATIONS

This application is a continuation of U.S. application Ser. No. 11/829,666 filed on Jul. 27, 2007.

### STATEMENT REGARDING FEDERALLY SPONSORED RESEARCH OR DEVELOPMENT

Not Applicable

### BACKGROUND OF THE INVENTION

1. Field of the Invention

The present invention relates to time and attendance systems for monitoring employees at a medical center, such as a hospital, and more particularly to a monitoring system that automatically monitors the use of particular resources and certain actions of employees.

2. Description of the Related Art

Healthcare employees and other employees at a medical center historically used a time clock to record the time of day on an attendance card upon entering and exiting the workplace. Today computerized time and attendance systems have replaced the traditional time clocks. These systems read an unique employee number and other data from an identification badge when the employee arrives and departs the workplace. The acquired employee identification data are transmitted and recorded in a central computer along with the current date and time. That recorded information is subsequently used by a payroll program to calculate the amount of wages that each employee is to receive.

Employees at medical facilities also must observe certain sanitary procedures, such as washing their hands before and after attending to a patient and wearing and disposing of certain protective garments during patient treatments. Therefore, it is desirable for hospital administrators to be able to verify that the employees are following the prescribed sanitary practices.

In other situations it is desirable to track employees' usage of specific types of resources to validate and measure the need for that particular resource. The medical center also may receive financial compensation based on the use of particular items, for example, a research funding can relate to equipment use. Such funding often requires the hospital to tally the amount of time that the employees devote to the research as compared to other tasks and to tally the usage of equipment and when it is accessed in that research program.

### SUMMARY OF THE INVENTION

Use of resources by a healthcare employee is monitored by locating a resource identification device adjacent each resource to be monitored. Each resource identification device emits a first wireless signal containing a resource identifier which in one embodiment is unique, thereby identifying the particular resource. In other applications, the resource identifier may be unique to a class of resources and thus a plurality of the resource identification devices associated with resources in that class would have the same resource identifier.

At least some of the healthcare employees carry a data acquisition device while at work. Each data acquisition device receives the first wireless signal when nearby one of the plurality of resource identification devices. In response to receiving the first wireless signal, the resource identifier transmitted by that signal is stored in the data acquisition device. Thereafter, all the stored resource identifiers are transferred from the data acquisition device to an to an external apparatus.

For example, the external apparatus may be a computer which is used to create reports specifying use of each resource by the healthcare employees.

### BRIEF DESCRIPTION OF THE DRAWINGS

FIG. 1 is a schematic diagram of a medical center computer system that stores information about hospital employees;

FIG. 2 is a block schematic diagram of an electronic resource identification device that is attachable to equipment in the medical center;

FIG. 3 is a block schematic diagram of another type of a resource identification device;

FIG. 4 is a block schematic diagram of the data acquisition device carried by the healthcare employee;

FIG. 5 is a graphical representation of data fields of a resource event record stored within the data acquisition device;

FIG. 6 is a diagram of part of a floor in the medical center in which an employee monitoring system has been installed;

FIG. 7 illustrates a resource identification device attached to an item of apparel that can be worn by a healthcare employee;

FIG. 8 shows a resource identification device attached to training manual;

FIG. 9 is a file folder to which a resource identification device is attached;

FIG. 10 illustrates the healthcare employee adjacent a personal computer into which data from the data acquisition device is being transferred;

FIG. 11 is a block schematic diagram of a data reader connected to the personal computer in FIG. 10;

FIG. 12 is a block schematic diagram of a data collector that also is used to acquire data from the data acquisition devices; and

FIG. 13 is a graphical representation of data fields of a resource usage record stored within the personal computer or the data collector.

### DETAILED DESCRIPTION OF THE INVENTION

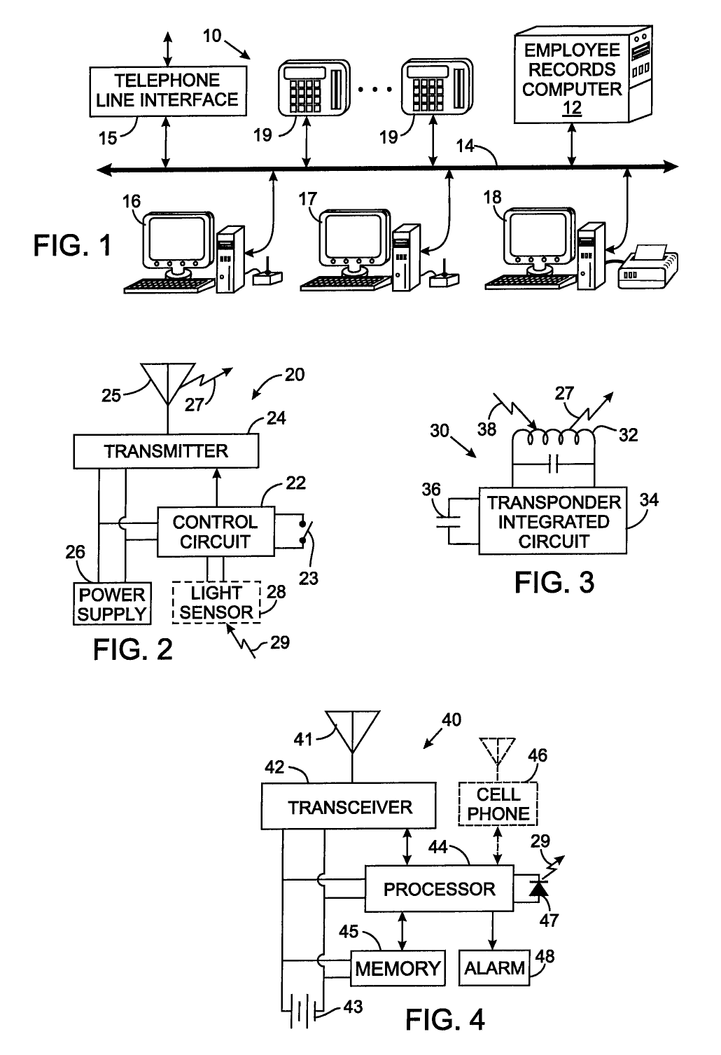

FIG. 1 illustrates a computer system 10 of a medical center, such as a hospital, outpatient clinic, nursing home, or extended care facility, for example. The computer system 10 includes a computer 12 that processes and stores employee records, which is utilized to schedule employees and then track the actual amounts of time that they work. For the purposes of the present employee monitoring system, the employee records computer 12 also receives and stores additional information about the activity of the employees and the resources that each one uses. The employee records computer 12 is connected to a local area network (LAN) 14, such as one commonly found in workplaces. A plurality of personal computers 16, 17 and 18 are connected to the LAN 14 to exchange data and commands with the employee records computer 12. It should be understood that many more personal computers than are illustrated are connected to the LAN 14 throughout the medical center. For example, personal computers are located at nursing stations, treatment areas, and administrative offices. The computer system 10 is typical of a relatively large medical center, whereas the present invention also can be used where the healthcare employees are supervised from one or more rooms in an office building. In this latter case computer system 10 could consist of a single personal computer.

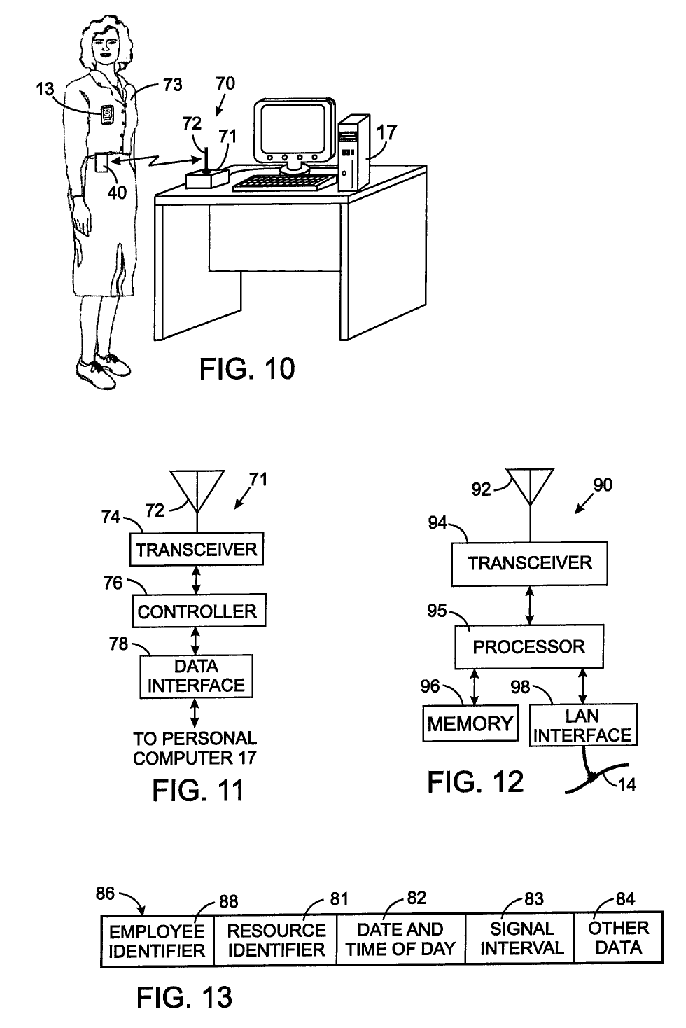

Employees working at the medical center register when they start and end periods of work using one of many badge readers 19 located throughout the medical center and connected to the local area network 14. The badge readers 19 can be any of a number of commercially available types. For example, each employee is issued an identification badge 13 (FIG. 10) that has a magnetic strip, barcode, or other mechanism which encodes a unique employee identifier (e.g. identification number) and the badge is read by the badge reader 19. This process enters employee time and attendance data into the computer system.

The computer system 10 also incorporates components for monitoring the use of particular resources at the medical center. As used herein, resources comprise things such as rooms, pieces of equipment, sanitation apparatus, personal hygiene equipment, special garments, training equipment, documents and records, to name only a few examples. For that purpose, a separate electronic resource identification device is either attached to or placed adjacent each resource, the use of which is to be monitored. The resource identification device 20 is programmed with a resource identifier, such as a unique identification number that is assigned to the associated resource. Alternatively, the resource identifier may designate a class of resources, such as a sink or faucet of a rest room.

With reference to FIG. 2, the electronic resource identification device 20 has a control circuit 22 that governs the operation of the device and has the resource identifier stored therein. The components of the resource identification device 20 are connected to a power supply 26 that can be a battery or a circuit that receives electricity from an electrical outlet. A switch 23, connected to the control circuit 22, is used to activate the resource identification device upon installation. While operating, the control circuit 22 periodically activates a radio frequency (RF) transmitter 24 which modulates an RF carrier signal with the resource identifier using any standard modulation technique. The resultant first radio frequency signal 27 is applied to an antenna 25 from which the signal radiates in an omnidirectional pattern. The first RF signal 27 typically has an effective signal strength within only a few feet around the associated resource. The range is limited so that RF signals from nearby resource identification devices 20 will not interfere with each other, however conventional signal collision avoidance techniques also may be employed to mitigate such interference. Because of that limited signal range, an employee must be relatively close to the resource in order for the resource usage to be logged, as will be described hereinafter. The resource identification device 20 may be configured to periodically transmit the first RF signal 27 or may include a light sensor 28 to detect a coded light signal 29 that initiates transmission of the first RF signal 27 for a brief time interval.

Although the present monitoring system preferably employs radio frequency signals to convey commands and data between different devices, other types of wireless signals such as light within the infrared or visible spectrums, audible sound, ultrasound, or other forms of wireless communication can be employed. Therefore, the term wireless as used herein encompasses all techniques for transferring information between two devices that does not utilize a hardwired connection between those devices.

FIG. 3 depicts second type of electronic resource identification device 30 for placement near a resource. This second resource identification device 30 is passive in that it does not require a power source, such as a battery. Instead, the second resource identification device 30 comprises a conventional radio frequency transponder tag, such as the type that is commonly used to identify products or used as a key-card for a building entry system. The second resource identification device 30 has a tuned antenna 32 that is connected to a transponder integrated circuit 34, which may be any one of a number of commercially available devices, such as one of a family of products available from Texas Instruments Incorporated, Dallas, Tex. USA. The transponder integrated circuit 34 is powered by energy derived from a radio frequency signal received at antenna 32 and used to charge a capacitor 36. That stored charge provides a voltage for powering the integrated circuit 34. Because the second resource identification device 30 does not require power from a battery or a building electrical outlet, it can be utilized on resources where such power sources are impractical. For example, the second resource identification device 30 can be applied to a garment to be worn by an employee or to documents the use of which is desired to be monitored. When the transponder type second resource identification device 30 receives a second RF signal 38, it becomes energized which results in the first RF signal 27 being transmitted from antenna 32. That first RF signal 27 is modulated with the resource identifier which has been programmed into the second resource identification device 30.

The signals transmitted by the resource identification devices are received by data acquisition devices 40 that healthcare employees wear on their clothing or otherwise carry while at work. Referring to FIG. 4, the data acquisition device 40 includes an antenna 41 that is connected to a transceiver 42, which has a transmitter section and a receiver section tuned to the first RF signal 27. Upon receiving that signal from a resource identification device 20, the transceiver 42 demodulates the signal and extracts the resource identifier. The extracted resource identifier is stored by a processor 44 in a memory 45. The processor executes a software program that also is stored in the memory 45 and which controls the operation of the data acquisition device 40. A battery 43 powers the components of the data acquisition device 40. If the resource identification devices 20 are activated by a light sensor 28, the data acquisition device 40 includes at least one infrared light emitter 47. The processor 44 periodically activates the light emitter 47, which produces a wide beam 29 of infrared light which may be modulated to provide a coded light signal to activate any nearby resource identification device 20. The processor 44 also activates an alarm 48, which may produce a sound or vibration much like a cellular telephone, to alert the employee carrying the data acquisition device 40.

For use with the second resource identification device 30, that is a passive transponder, the data acquisition device 40 carried by an employee is modified to periodically, every second or so, emit a second radio frequency signal 38 to which the second resource identification device is tuned. Upon receiving that second radio frequency signal, the transponder integrated circuit 34 becomes energized by power derived from that signal. This causes the second resource identification device to emit the first radio frequency signal 27 that carries the unique resource identifier which is stored within the transponder integrated circuit 34. The data acquisition device 40 processes the resource identifier in that same manner as described previously.

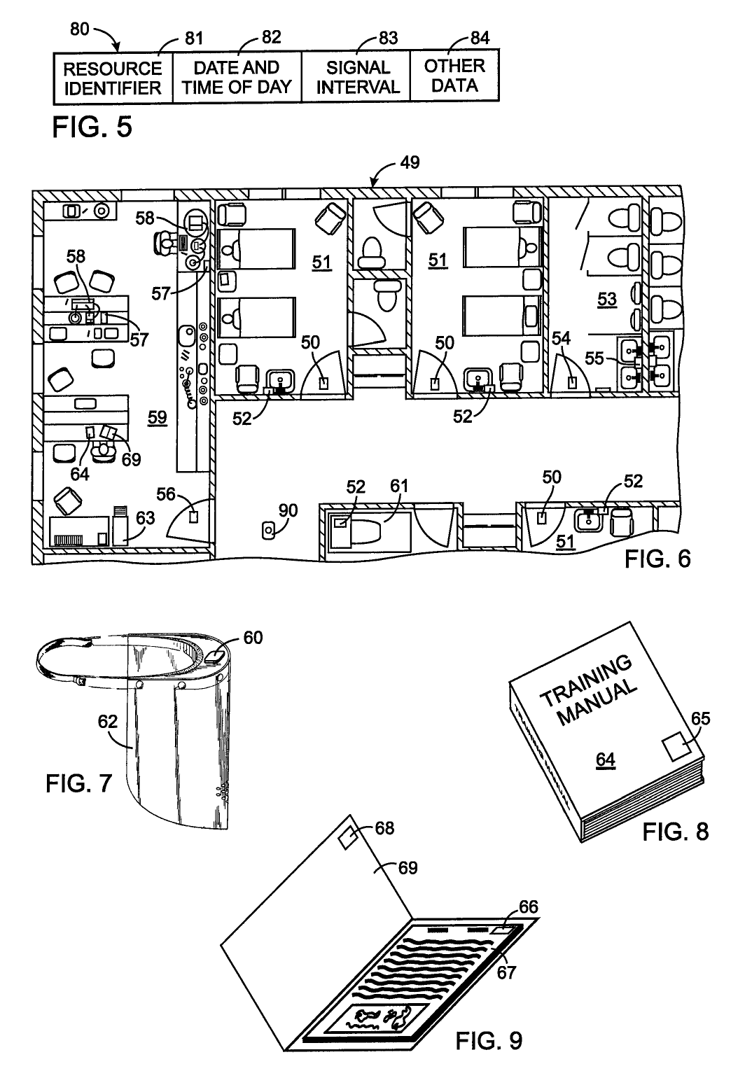

When a healthcare employee is within the range of the first RF signal 27 emitted by an resource identification device 20 or 30, the employee's data acquisition device 40 shown in FIG. 4 begins receiving the associated resource identifier. That event causes the processor 44 to record the resource identifier, the date, and time of day in the memory 45. At that time, the processor 44 also starts a software based timer to measure the time period during which the first RF signal 27 containing the same resource identifier continues to be received. Since the first type of resource identification device 20 transmits the first RF signal at predetermined intervals, if a defined number of intervals pass without receiving a radio frequency signal, the data acquisition device 40 concludes that an employee is no longer proximate to the resource identification device. Upon reaching that conclusion (which can also be reached through analysis of the recorded data), the processor 44 terminates the timer and stores the timer's final value into a location in memory 45 that is associated with the most recently stored resource identifier. Thus, the memory 45 now contains an event record 80 as depicted in FIG. 5 that has data fields for the resource identifier 81, the date and time of day 82, the interval that the first RF signal was received 83, and any other data 84 that was sent from the respective resource identification device 20 or 30.

Thereafter, if the healthcare employee reenters the range of the same first RF signal 27, a new set of storage locations within memory 45 are employed to retain another event record with the same resource identifier.

The data acquisition device 40 also may measure the strength of the first RF signal 27 received from a resource identification device 20 or 30 as indicating the proximity of the employee to the associated resource. The RF signal strength measurement denotes the relative proximity to a resource identification device and, along with the signal interval, is used to distinguish when an employee is merely passing close to a resource or is actually using the resource.

With reference to FIG. 6, the resource identification devices are located throughout the medical center 49 on or near resources, the uses of which are to be monitored. For example, each patient room has one resource identification device 50 located in the ceiling near the entrance to the room and another resource identification device 52 is located immediately adjacent the sink for the patient room. For example, this latter device 52 could be incorporated into the faucet for the sink. The identification device 50 for each patient's room could provide a unique resource identifier for each room. The additional resource identification device 52 could simply identify the type of resource as being a sink, as it is not important which sink it used, but rather that any sink is used, as will be described.

In a public restroom 53, a further resource identification device 54 is located in the ceiling so that a person using the toilet or urinal passes underneath that device. Each restroom has yet another resource identification device 55 located on the wall behind the sinks. Instead of a single ceiling mounted device, a separate resource identification device 54 can be provided at each toilet and urinal and a separate resource identification device 55 could be provided for each sink within the restroom.

Another resource identification device 52 can be positioned on or adjacent an piece of medical equipment 61 used to treat a patient.

The medical center 49 also has a research laboratory 59 at which work is conducted that is funded by a research grant. It is common that the work performed under a research grant must be documented, which necessitates that the activities of employees performing that work be monitored. Therefore, a resource identification device 56 is located near the entrance to the room in order to log people entering and leaving the laboratory. Additional resource identification devices 57 are attached to key pieces of laboratory equipment 58, the use of which is desired to be monitored.

Referring still to FIG. 6, when a healthcare employee enters a patient's room 51, the first RF signal from the resource identification device 50 on the ceiling in that room is received by the employee's data acquisition device 40. In response, the data acquisition device 40 records the current date and time of day and the resource identifier carried by that first RF signal which indicates that patient room. Prior to and after attending to the patient, the healthcare employee is required to wash his or her hands at the sink in the patient room 51. That action places the employee's data acquisition device 40 in proximity to another resource identification device 52 adjacent the sink. Once again the employee's data acquisition device 40 receives another first RF signal and stores the different resource identifier carried by that signal which identifies the sink. Optionally, the data acquisition device 40 may activate a timer that measures the interval that each first RF signal continues to be received and at the termination of which, the time interval measurement is recorded along with the resource identifier in the memory 45 of the data acquisition device. This recorded time interval measurement provides a indication of how long the healthcare employee was at the sink, thereby inhibiting the employee from merely passing near the sink to record the resource identifier without actually washing his or her hands.

If the healthcare employee leaves a patient's room without washing his/her hands, the data acquisition device 40 may be configured to issue a warning of that breach in hospital protocol. For example, if the data acquisition device records two consecutive passes beneath the same room resource identification device 50 without receiving between those passes a signal from a resource identification device 52 adjacent the sink, the alarm will be activated.

When the healthcare employee enters a rest room 53, the first RF signal from the resource identification device 54 on the ceiling in that room is received by the employee's data acquisition device 40. The resource identifier from the identification device 54 is recorded in the employee's data acquisition device 40. In fact when the healthcare employee leaves the toilet or urinal, the employee again passes beneath the resource identification device thereby recording the same resource identifier for that restroom in his data acquisition device 40. Thereafter when the employee's hands are washed, his data acquisition device 40 records the different resource identifier from the resource identification device 55 adjacent the restroom sink. This activity produces event records 80 in the employee's data acquisition device 40 that indicate use of the toilet or urinal and subsequent use of the sink, as required by the sanitary practices of the medical center. The data acquisition device 40 also may generate an alarm, if the employee leaves the rest room 53 without visiting the sink.

The resource identification device 56 on the ceiling of the research laboratory 59 and the other resource identification devices 57 attached to pieces of laboratory equipment 58, similarly produce event records 80 in the data acquisition devices 40 of the employees working in that room. Those event records 80 indicate how long a time period and when each employee was in the research laboratory and which pieces of laboratory equipment 58 that person used.

In addition to locating the resource identification devices on the ceilings and walls of the medical center and on pieces of medical equipment 61, those devices may also be attached to smaller objects for use monitoring. As shown in FIG. 7 for example, an identification device 60 can be attached to an article of apparel, such as a surgical face shield 62, that is worn by an employee. Additional identification devices can be attached to surgical gowns, radiation shields, and other types of garments or other articles of apparel that employees are required to wear during certain treatment procedures. The data acquisition device 40 also may generate an alarm, if the employee fails to put on a required article before entering a treatment or operating room or fails to dispose of that article in an approved receptacle.

Healthcare professionals are required periodically to take training courses. Some of these courses are formal classes lead by an instructor and other courses involve the employee using self-training materials. The use of self-training materials also can be monitored by placing a resource identification tag thereon. For example in FIG. 8, a training book 64 has a resource identification tag 65 attached thereto. The tag can be placed in any location on or in the book. In addition, the resource identification devices can be attached to documents, such as other training materials or patient records for HIPAA compliance purposes. For example, FIG. 9 shows a document 67 with a resource identification tag 66 affixed thereto. Alternatively, a resource identification device 68 can be attached to the file folder 69 containing the document or the file cabinet 63 in the research laboratory 59 shown in FIG. 6 or other area of the medical center 49. Preferably, the second type of resource identification device 30 is attached to documents, file folders, and books because of the device's relatively small size and thinness.

Referring to FIGS. 1 and 10, the data stored in the data acquisition device 40 are occasionally transferred into the computer system 10 of the medical center via a plurality of data readers 70 connected to the LAN 14. One type of data reader 70 is connected to personal computers 16 and 17 located throughout the medical center 49 and configured as patient information transfer stations. With particular reference to FIG. 10, personal computer 17 is connected to a data interrogator 71 which acquires the stored information from the data acquisition device 40 and conveys that information to the personal computer.

With additional reference to FIG. 11, the interrogator 71 has an antenna 72 that is connected to a transceiver 74 which exchanges commands and data with a controller 76 and passes that data through a data interface 78 to the personal computer 17. Periodically, such as every second or two, the interrogator 71 transmits a third radio frequency signal carrying an interrogation command. When a healthcare employee 73 carrying a data acquisition device 40 is within approximately ten feet of the interrogator 71, the data acquisition device 40 responds to the interrogation command. Specifically, the transceiver 42 extracts the interrogation command from the received third radio frequency signal and sends that command to the processor 44 (see FIG. 4). Upon receiving an interrogation command, the processor 44 executes a software routine which reads memory 45 to obtain a unique identifier assigned to the particular data acquisition device 40. This latter identifier designates the particular data acquisition device 40 and thus the specific healthcare employee 73 to whom the device was issued. Thus the identifier assigned to the data acquisition device is referred to as an employee identifier. As used herein, the terms “resource identifier” and “employee identifier” refer generically to identifiers that may contain only numerals (i.e. numbers), only alphabetic characters, or a combination of alphanumeric characters, as well as other characters. The employee identifier is sent to the data acquisition device's transceiver 42 which modulates a radio frequency carrier with that number and applies the resultant fourth radio frequency signal to the antenna 41. Then the software routine being executed by the processor 44 sequentially acquires all the resource event records 80 (FIG. 5) stored within memory 45. Those resource event records are transferred to the transceiver 42 which sends that data via the fourth radio frequency signal to the antenna 41. Thus, the data acquisition device 40 responds to the interrogation command by transmitting a return signal that contains its employee identifier and the stored resource event records 80. For security reasons, the transmission of the employee identifier may be encrypted, using a conventional algorithm, in order to prevent interception of the return signal and misuse of the identifier.

That interrogation reply carried by the fourth radio frequency signal is received by the interrogator antenna 72 and applied to the receiver section of the transceiver 74 in FIG. 11. The transceiver 74 demodulates the fourth radio frequency signal extracting the information carried by that signal. The healthcare employee identifier and all the resource event records 80 are transferred through the data interface 78 to the personal computer 17. The personal computer temporally stores the information received from the data acquisition device 40 as a series of resource usage records 86, one of which is represented in FIG. 13. Each resource usage record 86 comprises five data fields that respectively contain the healthcare employee identifier 88, resource identifier 81, the date and time of day 82, the interval that the first RF signal was received 83 by the employee data acquisition device 40, and any other data 84 sent by respective the resource identification devices 20 or 30.

Alternatively, the data reader 70 may comprise a cable that connects the data acquisition device 40 directly to the personal computer 17 and a software routine that is executed by that personal computer. The software routine issues the interrogation command via the cable to the data acquisition device and obtains the stored resource event records 80. In this case the transmitter section of the data acquisition device's transceiver 42 is configured to send the over that cable. Other types of data readers that perform this function can be employed.

As a further alternative, the data readers 70 also can include a plurality of wireless data collectors 90 connected to the computer network 14 and using technology similar to wireless Internet access. As shown in FIG. 12 each of the collector 90 has an antenna 92 connected to a transceiver 94 which exchanges commands and data with a processor 95, such as a microcomputer, for example. The resource event records 80 gathered by the data collector 90 are stored temporarily in a memory 96 along with the date and time of day that the respective signal from the resource identification device 20 or 30 was received. Periodically the data collector 90 uses a LAN interface circuit 98 to transfer the resource event records 80 over the LAN 14 in the medical center to the employee records computer 12.

The data collectors 90 are located in hallways and other areas of the medical center as depicted in FIG. 6 through which many medical employees pass throughout the day. The data collectors 90 gather the data from the data acquisition device 40 as the employees walk around the medical center without having the employee stand near a personal computer 16 or 17 to which a data reader 70 is connected.

Alternatively the data records can be transferred from the data acquisition device 40 to the employee records computer 12 via a cellular telephone call. For this variation, the employee's data acquisition device 40 in FIG. 4 includes an optional cellular telephone 46 that under the control of the processor 44 calls the medical center's computer system 10 at a predefined time of day. The local area network 14 in the medical center has a telephone line interface 15 to receive the calls from the data acquisition devices 40 and forward the stored resource event records 80 to the employee records computer 12.

After all the stored resource event records 80 have been acquired from the data acquisition device 40, the personal computer 16 or 17 or a wireless data collector 90 transfers that information over the computer network 14 to the employee records computer 12 at which the information is stored. The resource usage records 86 stored in the employee records computer 12 can be analyzed to provide various reports for medical center administrative purposes. For example, the records for each resource can be grouped to provide a report indicating the amount of use and the employees who used that resource. This is useful because it documents the use of facilities and resources dedicated to a particular research program, for example. Alternatively, the records for each employee can be grouped to provide a report indicating that person's activities throughout the work day, the resources that were used, and the amount of each resource's use. The reports also confirm that each employee has complied with requirements related to sanitation, training, the Health Insurance Portability and Accountability Act, and the Joint Commission on Accreditation of Healthcare Organizations.

The foregoing description was primarily directed to preferred embodiments of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

What is claimed is:

1. A method for monitoring activity and use of resources by healthcare employees, said method comprising:
locating a separate one of a plurality of resource identification devices adjacent each resource use of which is to be monitored, wherein each resource identification device emits a first wireless signal containing a resource identifier;
a plurality of the healthcare employees each carrying a separate data acquisition device;
each data acquisition device receiving the first wireless signal when proximate to one of the plurality of resource identification devices; and
each data acquisition device recording the resource identifier carried by the first wireless signal; and
creating a report using the resource identifiers recorded in the data acquisition devices.

2. The method as recited in claim 1 wherein the data acquisition device is assigned an employee identifier; and creating a report uses the employee identifier.

3. The method as recited in claim 1 further comprising the data acquisition device recording date and time of day that the first wireless signal is received.

4. The method as recited in claim 1 further comprising the data acquisition device recording an indication of an interval of time in response to receipt of the first wireless signal.

5. The method as recited in claim 1 wherein at least one of the plurality of identification devices periodically emit the first wireless signal.

6. The method as recited in claim 1 wherein:
the data acquisition device transmits a second wireless signal; and
one of the plurality of identification devices responds to receiving the second wireless signal by emitting the first wireless signal.

7. The method as recited in claim 1 further comprising:
sending a wireless interrogation signal to the data acquisition device; and
the data acquisition device responding to the wireless interrogation signal by transmitting the resource identifier via another wireless signal.

8. The method as recited in claim 1 the report that is created indicates areas of a medical center visited by a plurality of healthcare employees.

9. The method as recited in claim 1 wherein the report that is created indicates equipment used by the plurality of healthcare employees.

10. The method as recited in claim 1 wherein the report that is created indicates documents accessed by the plurality of healthcare employees.

11. The method as recited in claim 1 wherein the report that is created indicates whether a healthcare employee was adjacent a sink at least one of before and after attending to a patient.

12. The method as recited in claim 1 wherein the report that is created indicates whether a healthcare employee was adjacent a sink after using a toilet or urinal.

13. The method as recited in claim 1 wherein the report that is created indicates use of a document by a healthcare employee.
